(19) United States
(12) Patent Application Publication
(10) Pub. No.: US 2008/0286438 A1
(43) Pub. Date: Nov. 20, 2008

(54) Container System for Successively Producing Multiple Servings of Reconstituted Liquid Product

(76) Inventor: Gregory James Newell, Spokane, WA (US)

Correspondence Address: GREGORY;NEWELL, 3223 NORTH MARKET STREET, SPOKANE, WA, 99207, US

(21) Appl. No.: 12/093,289

(22) PCT Filed: Nov. 13, 2005
(86) PCT No.: PCT/AU05/01715

§ 371 Date: May 9, 2008

(51) Int. Cl. A23L 3/015; B65D 25/08

(52) U.S. Cl. 426/665; 29/700; 206/222

(57) ABSTRACT

A container system (10) for producing a. beverage from a beverage concentrate, the container system including a container for holding a liquid volume, the system having a mounting system coupled thereto for holding at least one carrier (20-1), wherein each carrier has multiple compartments (21) comprising the beverage concentrate, the system further having a cutting system coupled thereto for piercing at least one of the multiple compartments (21), wherein, when the at least one of the multiple compartments (21) is pierced the beverage concentrate is commingled with the liquid volume to produce the beverage within the container (10).

### BACKGROUND OF THE INVENTION

1. Field of the Invention

The present invention relates to methods and apparatus for reconstituting a liquid product and a container system for successively producing multiple servings of reconstituted liquid product, such as beverage or food products.

2. Description of the Related Art

The beverage market has seen, and continues to see, substantial expansion, both in the range and volume, of beverages that are consumed. The broadening of consumer tastes and demands, the increasing sophistication of beverages with respect to the ingredients and virtues they possess, and the unrelenting trend towards “consumer convenience” have resulted in significantly more beverages being offered in almost every category, plus the creation of new categories such as “energy drinks” and “herbal and elixir” beverages. So, while thirty years ago the refrigerated beverage section of a retail store may have been quite compact with just a few beverage choices available, today many more retail outlets offer beverages (refrigerated and un-refrigerated) with aisle after aisle of choices.

As one might imagine, successful marketing of the plethora of beverages available requires unique packaging and almost always calls for single use containers. Such marketing is understandably “environmentally unfriendly” as this requires excess expenditures of energy, and an overwhelming burden of waste containers.

Increasing knowledge on beverage ingredients and improved manufacturing methods and technologies have allowed the creation of many new beverages, while also greatly improving the efficiency of the manufacturing process that creates them. Perhaps one of the most significant efficiencies in beverage manufacture has been the beverage manufacturer's practice of bulk producing a (typically liquid form) “concentrate” of their beverage and then shipping the concentrate to plants that are set up to do the final mixing and packaging of numerous different types of beverages. Generically referred to as “bottling plants”, they mix the concentrate with numerous other more standardized ingredients such as sugar and carbon dioxide before adding what is (by definition) the primary ingredient of all beverages, being “purified water”, before packaging the beverages for distribution through a more localized retail network. This distributed, two-stage production method significantly reduces the total transportation costs by reducing the total distances that the water and consumer packaging has to be transported. However, the efficiencies achieved up to the bottling stage are arguably minimized by the inefficiencies of the subsequent stages dealing with the handling of the reconstituted beverage through to its final consumption. These inefficiencies can be broadly categorized as warehousing and distribution, point-of-sale storage and display, and consumer acquisition and consumption.

The concept of supplying a beverage in concentrated form such that the consumer “reconstitutes” the product by adding water is not in itself new. While there remains to be a market for beverage concentrates in liquid and powder forms, there has been an absence of an effective convenient system for reconstituting beverages at a personal level.

Some examples of proposed approaches to systems for reconstituting beverages are disclosed in various patents and patent application publications. Consider the following examples:

U.S. Patent Appl. No. 2004/0007594 “Bonus Flavor Dispenser” discloses a device for adding a secondary fluid to a primary fluid stream. A flow control device may be positioned so as to control the amount of fluid added. The device disclosed does not provide even mixing throughout the primary fluid and is limited to a single serving.

A series of similar devices are disclosed in U.S. Patent Appl. No. 2004/007481 “Container Closure Containing a Mix”; U.S. Patent Appl. No. 2003/0213709 “Beverage Storage and Discharge Dap Assembly”; U.S. Pat. No. 5,971,140 “Apparatus for Mixing a Fluid and a Liquid”; U.S. Pat. No. 6,230,884 “Discharge Cap with Releasable Tablet Basket”; U.S. Pat. No. 6,540,070 “Water Bottle Attachment with Releasable Concentrated Flavor.” These devices do not provide a consumer with a versatile system.

For example, '7481 discloses a container closure for unsealing a mix to be mixed with the liquid in a liquid container to flavor the liquid when the container is attached to the liquid container. The container closure disclosed in this application also is limited to a single serving (volume) of liquid. '3709 is also limited to a single serving (volume) of liquid, as are the devices disclosed in '140, '884 and '070. Furthermore, a manufacturer will readily recognize that these devices will likely be costly to manufacture and may not provide for commercial success in a competitive industry.

The vast majority (if not all) of the beverage concentrates being offered on the market are intended to be mixed into a large container from which individual servings can be poured. The “multiple servings” (as opposed to “single serving”) sizing of the concentrate, plus the absence of an effective system for mixing them means that concentrates are not appropriate for immediate consumption purchases.

Consequently, a need exists for a beverage system that provides consumers with variety and portability, with attendant improvements in manufacturing and distribution costs, which preferably reduces the environmental burden created by waste beverage containers.

### BRIEF SUMMARY OF THE INVENTION

In satisfaction of the aforementioned need, the present invention provides a method and a container system for successively producing, when desired and one at a time, multiple personal servings of reconstituted liquid product, such as beverage or food products. The container system is primarily targeted toward personal use by a consumer (user) to provide the consumer with the capability of unsealing one at a time each of a plurality of discrete quantities of beverage or food concentrate for mixing the unsealed concentrate with a liquid, such as water, to produce the reconstituted liquid product in a container from which the reconstituted product can then be consumed by the user. The quantities of concentrate can be the same or different.

Various embodiments of the invention may be had. For example, in a first embodiment, the container system employs three separate parts: a container, a holder and a base. Only the holder, that stores the discrete quantities of concentrate, needs to be replaced. Both the container, that holds the liquid to be mixed with each unsealed quantity of concentrate, and the base, that is used to support the holder in an end portion of the container, can be reused.

Disclosed herein is a beverage container system for preparing a beverage from a beverage concentrate, the container system including a container for holding a liquid volume, the system further having a mounting system coupled thereto for holding at least one carrier, wherein each carrier has multiple compartments comprising the beverage concentrate, the system further having a cutting system coupled thereto for piercing at least one of the multiple compartments, wherein, when the at least one of the multiple compartments is pierced the beverage concentrate is commingled with the liquid volume to produce the beverage within the container.

Also disclosed is a method for producing a beverage container system for preparing a beverage from a beverage concentrate, including selecting a mounting system for holding at least one carrier having multiple compartments includes the beverage concentrate; selecting a cutting system for piercing at least one of the multiple compartments; selecting a container for holding a liquid volume; and coupling the mounting system and the cutting system to the container to produce the container system.

Further included is a method for producing a beverage, that includes selecting a container for holding a liquid volume, the container having a mounting system coupled thereto for holding at least one carrier, wherein each carrier has multiple compartments including the beverage concentrate, the container further including a cutting system coupled thereto for piercing at least one of the multiple compartments, wherein, when the at least one of the multiple compartments is pierced the beverage concentrate is commingled with the liquid volume to produce the beverage within the container; filling the container with the liquid volume; mounting at least one carrier into the container; and piercing at least one of the multiple compartments.

Also disclosed is a beverage concentrate container that includes a carrier adapted for use in a container system, the container system having a cutting system for releasing the beverage concentrate supply, the carrier having multiple compartments for containing at least one beverage concentrate and at least one covering there over for sealing the beverage concentrate within each of the multiple compartments.

Further disclosed is a beverage container system for preparing a beverage from a beverage concentrate, the beverage container system including a container means for holding a liquid volume, the container means having a mounting means coupled thereto for holding at least one carrier means, wherein each carrier means has multiple compartments including the beverage concentrate, the beverage container system further having means for cutting coupled thereto, the cutting means for releasing beverage concentrate from at least one of the multiple compartments, wherein, when the beverage concentrate is released, the beverage concentrate is commingled with the liquid volume to produce the beverage within the container means.

### BRIEF DESCRIPTION OF THE DRAWINGS

In the following detailed description, reference will be made to the attached drawings in which:

FIG. 1 is a side view of two assembled sizes of containers for a first type of container system of the present invention;

FIG. 2 is an exploded side view of the system of FIG. 1;

FIG. 3 is an exploded side perspective view of the base, a cup-type carrier, the seal and the lower portion of the container of FIG. 1;

FIG. 4 is a bottom view of the container of FIG. 1, with the base and carrier removed;

FIG. 5 is a side view of the cam layout encircling the container of FIG. 1;

FIG. 6A and FIG. 6B, collectively referred to as FIG. 6, are sectional views of the container system of FIG. 1 where the base is rotated from a first position in FIG. 6A to move the carrier to a second position in FIG. 6B;

FIG. 7 is a cut away side view of a second type of container system of the present invention;

FIG. 8 is a perspective view of a container for use with the system of FIG. 7;

FIG. 9A, FIG. 9B and FIG. 9C, collectively referred to herein as FIG. 9, are perspective views of a flapper and a cover housing for the container system of FIG. 7;

FIG. 10 is an exploded perspective view for a flow through type of carrier;

FIG. 11 depicts the flapper in an upward and relaxed position in relation to the cover housing and the carrier;

FIG. 12 depicts the flapper in a semi-depressed position in relation to the cover housing and the carrier;

FIG. 13 depicts the flapper in a fully depressed position in relation to the cover housing and the carrier;

FIG. 14 depicts a container system for use with a straw;

FIG. 15 depicts a second embodiment of the container system of FIG. 14; and,

FIG. 16 depicts a stack of carriers.

### DETAILED DESCRIPTION OF THE INVENTION

Various embodiments of the invention are disclosed herein. Two categories, referred to as a first type and a second type, may be practiced with a variety of embodiments thereof. Please note that reference numerals, as used herein, may make reference to aspects of the invention that are common between embodiments, or specific to a certain embodiment. For example, reference is made to a cup-type carrier 20-1 and also to a flow through carrier 20-2. In some instances, the differences between each type of carrier 20-1 and 20-2 are of little or no consequence. In such cases, reference is made to the item (carrier) in general terms as a carrier 20. Accordingly, one skilled in the art will recognize that aspects of the various embodiments may be interchanged as desired, and that the embodiments disclosed herein are only illustrative, and therefore not limiting of the invention.

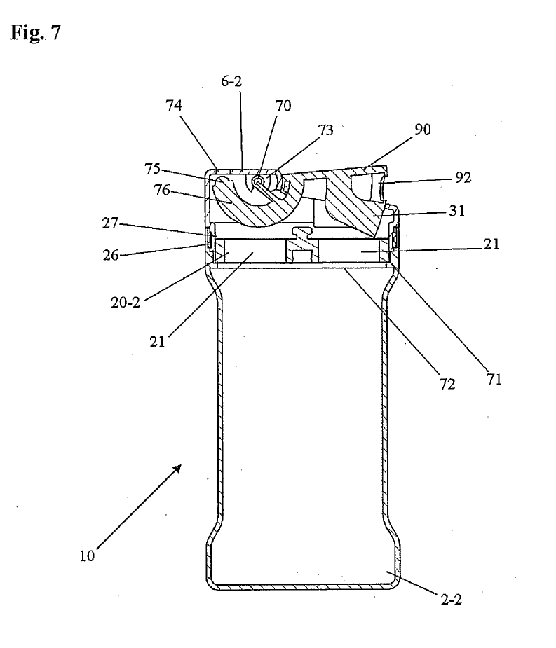

The first type of container system 10 for mixing a beverage from a beverage concentrate and dispensing the beverage for personal consumption is depicted in FIGS. 1-6. Aspects of the second type of container system 10 are depicted in FIGS. 7-16.

### First Type

Referring to FIG. 1, there is shown a container system 10. In this first embodiment, the container system 10 includes a cover 6-1, a container 2-1, and a base 4. In this embodiment, the cover 6-1 may be a lid of any suitable design known for reusable personal drink containers. For example, the cover 6-1 may be a screw on or snap on lid and may further contain a rotatable shutter to prevent spillage and provide access to contents on demand. The cover 6-1 can have a tiny vent hole and disposed opposite there from a larger flip opening from which a user can drink and also serve as an opening through which a person can pour water into the container 2-1 to refill it. The removability of the top cover 6-1 provides for easier manufacturing of the container 2-1 and facilitates its refilling and cleaning. If desired, a spout (not shown) can be provided on the top edge of the container 2-1. FIG. 1 depicts two sizes of containers 2, such as a 375 ml and a 750 ml volume. One will recognize that many different size containers 2 may be used.

Preferably, a standard size base 4 may be used with the various sizes of the container 2-1. The base 4, container 2-1, cover 6-1 and other components of the container system 10 may be manufactured from suitable materials. For example, the various components may be manufactured of food compatible plastic material by use of well-known injection molding techniques. Metal portions may be included as appropriate to provide for durability or ornamentation. For example, the container 2-1 may have a brushed metal jacket, such as without limitation, an aluminum jacket. Such components may be assembled by additional techniques such as screwing, gluing, interlocking, heat-bonding, melting as well as through other techniques. The container 2-1 may further include handles or other ornaments as desired. Preferably, the container 2-1 is formed of clear plastic, thus affording visual monitoring of the contents of the container 2-1. In some embodiments, a clear window is included to afford visual monitoring, while other portions of the container system 10 are non-transmissive for wavelengths of visible light. As techniques for manufacture of the aspects of the invention disclosed herein are well known, such aspects are generally not discussed further herein.

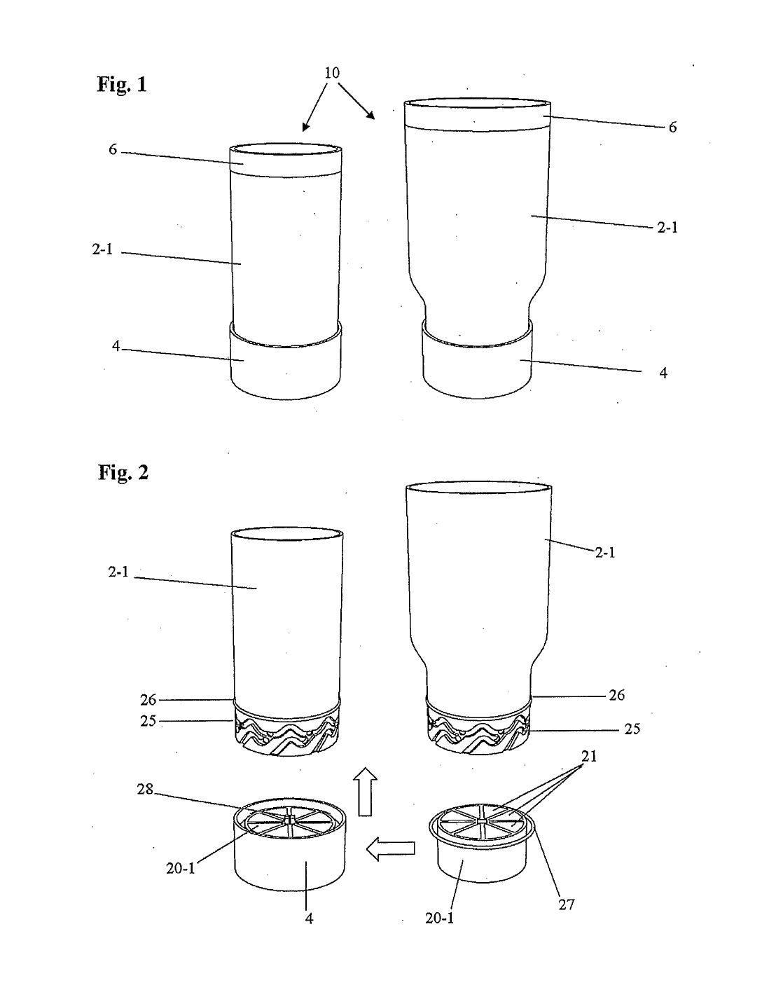

Referring to FIG. 2, there is shown a cam track 25 encircling the lower portion of the container 2-1. The portion of the container 2-1 having the cam track 25 is preferably bounded by a sealing recess 26. The cam track 25 provides a mounting system for the base 4, as well as a system for controlling aspects of manipulation of the base 4, which provides a mounting system for the carrier 20. The sealing recess 26 ensures adequate prevention of leakage of the contents of the container 2-1. The carrier 20 depicted is a cup-type carrier 20-1. Each carrier 20 has a plurality of compartments 21 for containing beverage concentrate. A second type of carrier 20, the flow-through carrier 20-2, is discussed further herein and with regard to the second type of container system 10.

In this first type and in the second type of container system described later herein, the carrier 20 is a carousel. One may recognize that the carrier 20 may include a variety of shapes, sizes, forms and other features.

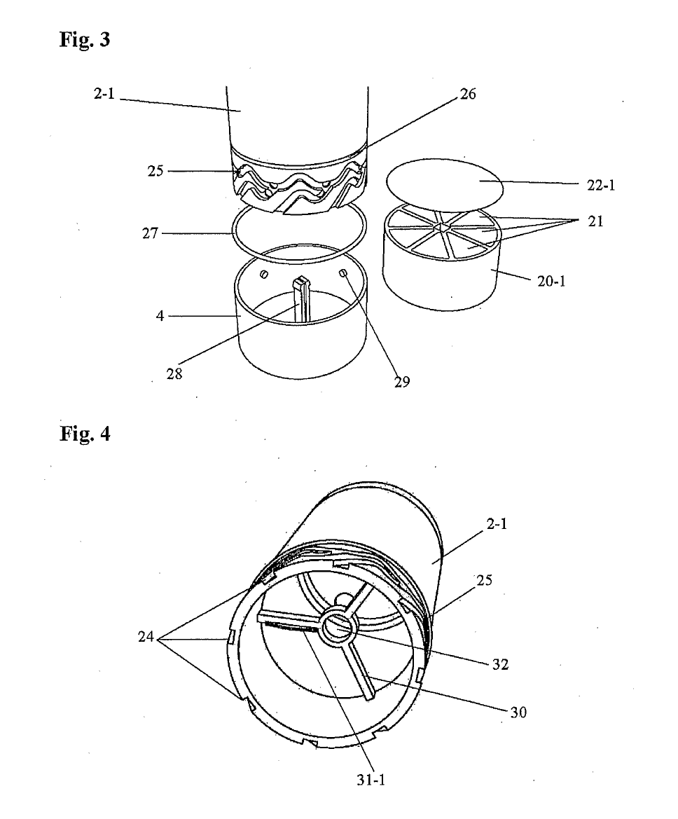

Preferably, the cup-type carrier 20-1 has a shaped body having a flat round bottom, a cylindrical outer sidewall, a central region and a plurality of radial partitions extending radially between and rigidly interconnecting the flat bottom, the outer sidewall, and the central region. Preferably, the central region includes a through passageway which permits insertion of a lock 28, which is attached to the base 4. The flat bottom, the outer sidewall and the radial partitions of each carrier 20 cooperate to define a plurality of pie-slice shaped separate and discrete compartments 21 there between. Each of the compartments 21, is adapted for storing a beverage concentrate, either liquid or powder, such as of a beverage or food, for mixing with a volume of liquid, such as water, where the volume is greater than that of the beverage concentrate, thus providing for production of a reconstituted liquid, such as a beverage or food product. Further aspects of the cup-type carrier 20-1 are illustrated in FIG. 3.

Although the carrier 20 is described herein as the cup-type carrier 20-1 or as a flow through carrier 20-2, these embodiments are merely illustrative and not limiting. For example, other possible embodiments of the carrier 20, which are not depicted herein, could include a “tube-like” carrier 20 wherein the carrier 20 has an outer shape extending down into the main container 2 (e.g., from top to bottom) and used with a container system 10 having apparatus for puncturing each compartment 21 through the side wall of the carrier 20. Alternatively, the carrier 20 could be tube-like and vertical but have rupturable walls between each compartment 21 so that a plunger could be pushed down from top to bottom, like a syringe plunger, rupturing and extruding the concentrate contents from each chamber. In summary, the carrier 20 could take a wide variety of shapes, sizes or forms while still providing the unique and novel function of containing multiple, individually releasable portions of beverage concentrate.

Referring to FIG. 3, a covering 22 (shown here as the top covering 22-1) for the carrier 20 is shown. Preferably, the covering 22 is a thin film made of a suitable rupturable material, such as a clear plastic, impervious to passage of a fluid there through. Preferably, the covering 22 is attached, such as by use of a suitable conventional heat sealing technique, on the edges of the cylindrical wall, over a central region and along partitions of the carrier 20 so as to cover the plurality of compartments 21 and thereby confine and seal the discrete quantities of beverage concentrate therein. Preferably, puncturing, delaminating, perforating or otherwise interrupting the sealing quality of the covering 22 sealing one compartment 21 would not result in the release of the beverage concentrate from any of the other compartments 21. Each carrier 20 may contain multiple servings of a single beverage concentrate, contain a variety of beverage concentrates, or any combination as desired.

One skilled in the art will recognize that a variety of techniques may be used to release the beverage concentrate from the carrier 20. Techniques disclosed herein are non-limiting and merely illustrative of ways to release the beverage concentrate from the carrier 20.

Also shown in FIG. 3 are aspects of the internal portion of the base 4. Included in the base 4 is the lock 28, which is preferably integrally molded into the base 4, and is attached to the base 4 in the central portion of the bottom of the base 4. Along the interior walls of the base is at least one cam follower 29. The cam follower 29 provides for secure mounting and circumnavigation of the base 4 along the cam track 25. The cam follower 29 is mounted into the cam track 25 through cam entry points 24, shown in FIG. 4.

The lock 28 may be included and attached to the base 4 to provide for secure positioning of the cup-type carrier 20-1 within the base 4. By way of example and not as a limitation, the lock 28 may be formed of a pair of back-to-back parts, which can be compressed toward one another from a normal relaxed spaced apart position. Hooks formed on upper ends of the parts may be included and preferably overlie the top edge of the center pedestal, so as to retain the lock 28 through the center of the cup-type carrier 20-1, and thus retain the cup-type carrier 20-1 fitted snugly into the base 4. As one alternative, the lock 28 could be in the form of a post of polygonal configuration which is press fitted into the through passage in the central region of the cup-type carrier 20-1. As another alternative, the lock 28 could be a series of structures (not shown), periodically located along the interior of the wall to the base, such as one hook every ninety degrees, thus providing for retention of the carrier 20 by overlying the outer wall of the carrier 20.

A user places the cup-type carrier 20-1 loaded with beverage concentrate into the base 4. A sealing ring 27 is also placed into the base 4 and over the carrier 20. Alternatively, the sealing ring may be an integrated portion of the base 4. Alternatively, the sealing ring 27 may be attached to or integrated with the sealing recess 26. Once the carrier 20 is loaded into the base 4, the loaded base 4 is attached to the container 2-1. Common to each embodiment in the first type of container system 10, the sealing ring 27 provides a structure for protecting against leakage of contents from the container 2-1.

Referring to FIG. 4, the container 2-1 is a generally cylindrical shaped body formed by a continuous cylindrical sidewall. The container 2-1 includes an open framework 30 extending between and attached at spaced portions of the interior surface of the sidewall of the container 2-1 adjacent to an end portion of the container 2-1. Preferably, the container 2-1 is open at a top end so that a user may easily pour a volume of liquid into the container 2-1 and gain access to the contents of the container 2-1 for consumption. The open framework 30 preferably, but not necessarily, can take the form of a central ring 32 and a plurality of radial arms, such as three in number, angularly displaced from one another and attached to and extending radially from the central ring 32 to the interior surface of the container 2-1 at which the radial arms are also attached. By having such configuration, the open framework 30 reinforces and supports the end portion of the container 2-1 which is otherwise weakened by the open bottom thereof while at the same time allowing easy passage and communication of the volume of liquid in the container 2-1 to the base 4. The framework 30 supports the cutting member 31 in the desired orientation.

The cutting member 31, which may be made of plastic or other suited materials, is preferably supported on the framework 30. The cutting member 31 faces toward the top covering 22-1 of the carrier 20 residing in the base 4 when mounted onto the container 2-1. Preferably, the cutting member 31 and framework 30 are integrally connected with the container 2-1, all being formed of the same material and during the same injection molding process. However, in some embodiments, the cutting member 31 may be subsequently installed. One example being a cutting member 31 formed from a metal clip (not shown) that is suspended from the framework 30. The cutting member 31 is configured and adapted to cut (rupture, sever, puncture or pierce) the top covering 22-1 adequately enough for the beverage concentrate contained in one compartment 21 to commingle and disburse into the volume of liquid. The cutting member 31 operates as the carrier 20 and base 4 are moved axially toward it and concurrently rotated relative to it. In one embodiment, when the base 4 is advanced and moved toward the cutting member 31, the protruding portion of the lock 28 helps to maintain orientation and limit axial motion of the base 4 by abutting the central ring 32 of the container 2-1. Once the carrier 20 and the base 4 are installed upon the container 2-1, the container system 10 can receive and hold a volume of liquid for mixing with the beverage concentrate.

Preferably, the sealing ring 27 encircles the container 2-1 at a location running circumferentially about an exterior surface of the container 2-1, preferably, but not necessarily, above the cam system 26. The sealing ring 27 is situated so as to seat in a sealing recess 26 formed in and circumscribing the exterior surface the container 2-1. In the various embodiments, the sealing ring 27 forms a seal between the container 2-1 and the base 4 when the base is installed on the container 2-1, so as to prevent leakage from the container 2-1.

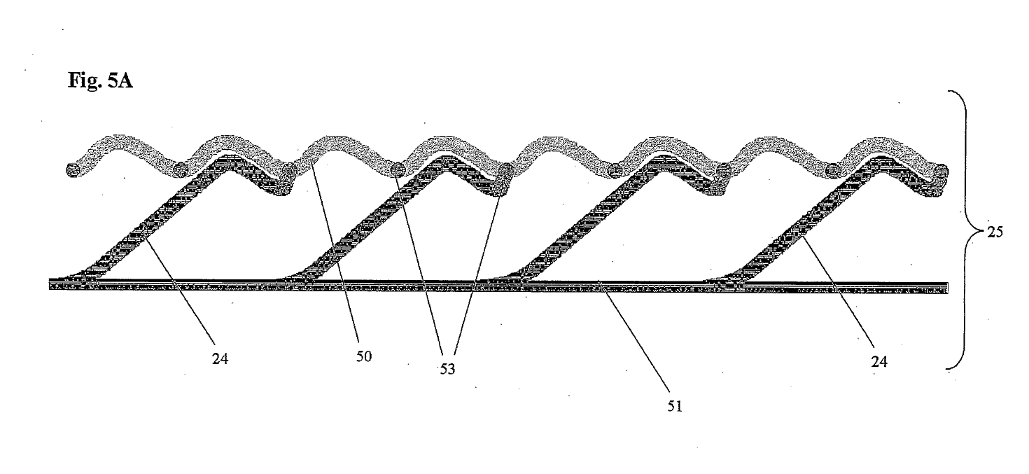

Referring now to FIG. 5, a cam system preferably includes a cam track 25 formed about the outside of the end portion of the container 2-1 and at least one, for cooperation with a cam follower 29 fixed on the interior surface of the sidewall of the base 4. The cam track 25 includes an undulating, or more specifically a sinusoidal-shaped, main path 50 defined by a main recess or groove formed in and about the exterior surface of the sidewall of the container 2-1, specifically around the end portion thereof. The undulating main path 50 is made up of alternating interconnected peak and valley portions defining raised and lowered positions for the base 4 as the base 4 is rotated relative to the container 2-1. The cam track 25 also includes a plurality of entry-exit auxiliary paths 24 defined by auxiliary grooves recessed in the exterior surface of the container 2-1 extending between and interconnected with the undulating main path between the peak portions thereof.

In FIG. 5 there is an auxiliary path 24 for every other valley portion of the cam track 25. In other embodiments, an alternative arrangement may be had where there is an auxiliary path 24 for every other peak portion. The undulating main path 50 of the cam track 25 is an endless path such that the base 4 and carrier 20 are moved by rotating the base 4 relative to the end portion of the container 2-1.

The cam follower 29 can take the form of a single lug or a plurality of lugs, such as four in number, that are fixed on the interior surface of the continuous sidewall of the base 4. Preferably, the cam follower 29 projects, by way of example 1-2 mm, into the annular space between the carrier 20 and the base 4. The lugs can be, by way of example, 4 mm in diameter. Preferably, the cylindrical lugs will fit snugly into the cam track 25 and act as the cam follower 29, tracing the main 50 and auxiliary path 24 of the cam track 25, as defined by the recessed grooves on the exterior surface of the container 2-1. With the carrier 20 installed in the base 4, the cam follower 29 are moved along the entry-exit auxiliary paths of the cam track 25, either into or from the undulating main path of the cam track 25, as the base 4 and carrier 20 are rotatably moved in either a “screwing” or “unscrewing” manner relative to the end portion of the container 2-1. In such manner, the end portion of the container 2-1 is removably installed or fitted within the annular space between the base 4 and the carrier 20. As seen in FIG. 5, an additional starter groove 51 may be provided which circumnavigates the bottom end of the container 2-1 and facilitates the lining up of the cam follower 29. Preferably, the auxiliary paths 24 of the cam track 25 each incorporate a hump that prevents unintentional removal of the base 4, which could result in spilling of the remaining contents if the base 4 were so removed.

Preferably, the main path 50 includes as many peaks as each carrier 20, such that each peak corresponds to one compartment 21 of the carrier 20. By use of this design, one complete rotation of the base 4 causes the emptying of each of each compartment 21 in one carrier 20. Indents 53 may be included in the cam track 25 to provide for resting points for the cam follower 29. As depicted in FIG. 5, the indents 53 are preferably located such that the base 4 rests in a lowered position relative to the cutting member 31. As one may surmise, the number of compartments 21 is determined by factors such as the volume of the container 2-1, the degree of concentration and the desired mixing ratios.

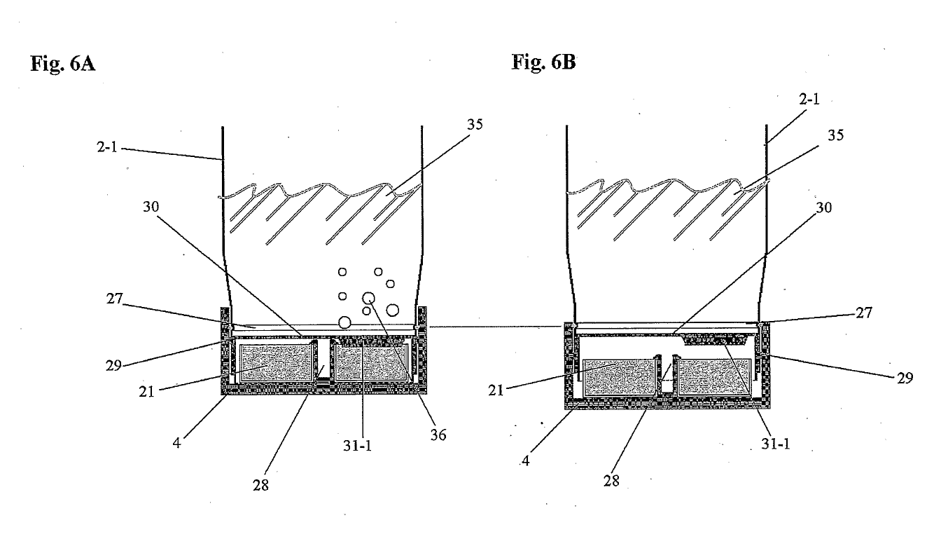

Preparing the first type of the container system 10 for use calls for selecting and loading a carrier 20 into the base 4. Preferably, a cup-type carrier 20-1 is used, however, in other configurations other carrier structures, such as a flow though carrier 20-2 (see FIG. 10) may be used (e.g., when the lock 28 includes structures along the inner wall of the base 4). Prior to coupling the base 4 to the container 2-1, the sealing ring 27 is loaded as may be appropriate. The base 4 having the carrier 20 loaded therein is then coupled with the container 2-1 by placing the base 4 against the bottom of the container 2-1 and rotating the base 4 relative to the container 2-1 such that the cam follower 29 enters into the auxiliary path 24 of the cam track 25. The user then continues to rotate the base 4 and the container 2-1 relative to each other such that the cam follower 29 enters the main path 50 of the cam track 25. Preferably, once the base 4 and the carrier 20 are secured into place, the base 4 is in a lowered position. That is, the container system 10 is axially elongated as the cam followers 29 of the base 4 are located within a valley of the cam track 25. At this point, the container 2-1 may be filled with a volume of liquid, such as water, through conventional methods for filling a drinking cup. FIG. 6B depicts a cutaway side view of the container system 10 wherein the base 4 is in the lowered position.

FIG. 6B depicts the carrier 20 loaded into the base 4. The carrier 20 is secured in place by use of the lock 28, which preferably has hooks that overlie a portion of the top of the carrier 20. As one can see in FIG. 6B, the compartments 21 are in an inferior position, some distance from the cutting member 31, and therefore not subject to puncture. Rotation of the base 4 relative to the container 2-1 causes the cam followers 29 to travel in an upward motion, drawing the base 4 in to the raised position. As shown in FIG. 6A, as the carrier 20 enters the raised position, the cutting member 31 operates to pierce the top covering 22-1. The piercing causes the beverage concentrate 36 to commingle with the volume of liquid 35. Thorough mixing of the beverage concentrate 36 and the volume of liquid 35 preferably occurs through conventional methods, such as stirring or shaking of the container system 10.

Withdrawal of the base 4 from the container 2-1 is accomplished in the same manner as coupling the base 4, wherein the base 4 is rotated such that the cam follower 29 is directed into the auxiliary pathway 24.

### Second Type

A second, and preferred embodiment of the container system 10 is disclosed in FIGS. 7-16.

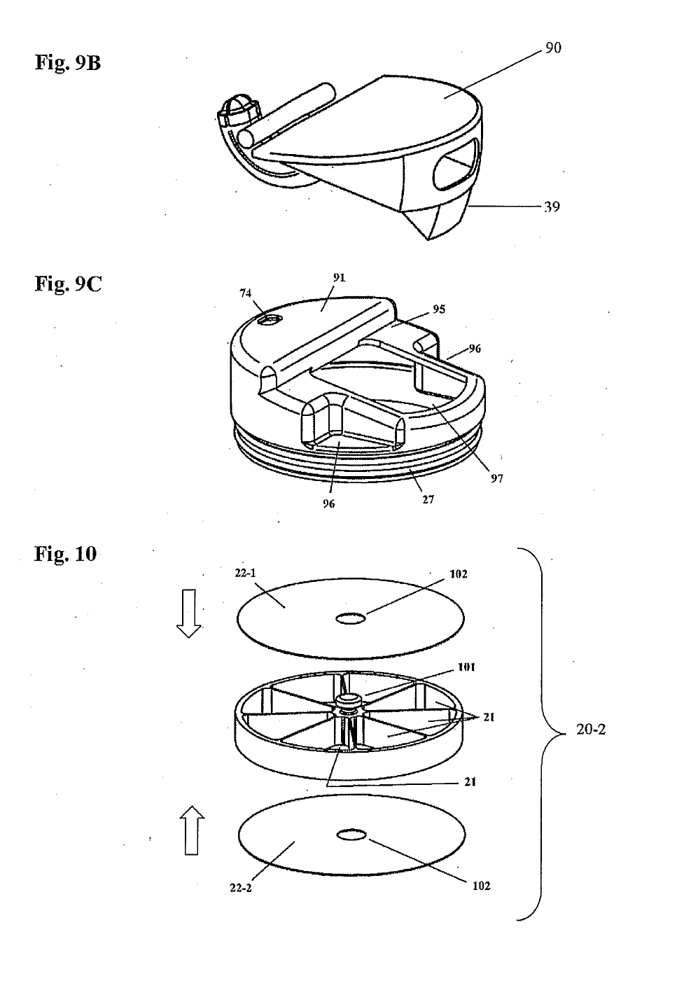

Referring to FIGS. 7, 8 and 9, there are shown aspects of embodiments of the preferred (or second type) of container system 10. In FIG. 7, the container 2-2 is closed at the bottom thereof. The cover 6-2 includes a flapper 90, shown in more detail in FIG. 9. In some embodiments, the flapper 90 (FIGS. 9A and 9B) is mounted into the cover housing 91 (FIG. 9C) by use of a hinge 70. Preferably, the mounting occurs through insertion of the flapper 90 through an opening 97 in the cover housing 91, and then twisting the flapper 90 into proper orientation. That is, the flapper 90 is twisted into an orientation such that the hinge 70 is coupled to a mount 73 within the cover housing 91. Preferably, the flapper 90 includes a spring arm 76 and spring termination 75. The spring arm 76 and spring termination 75 work together to maintain the flapper 90 in an upward position when the flapper 90 is installed in the cover housing 91. In other embodiments, other types of springs are substituted for the spring arm 76 and spring termination 75. Examples of other springs including, without limitation, a coil spring and a leaf spring. In order to operate the cutting member 31, the user simply depresses the flapper 90 until the flapper 90 comes into contact with the shelf 95. In other embodiments, the flapper 90 does not include spring loading. In these embodiments, the positioning of the flapper 90 is controlled by the user wherein the flapper 90 remains in the position selected by the user. Apparatus such as detents (not shown) may be included with these embodiments to provide for securely retaining the flapper 90 in the desired position.

Preferably, a spout 92 is included in the flapper 90 and provides an exitway for contents from the container 2-2. In some embodiments having a spout 92, the flapper 90 includes sidewalls 93 for the exitway, the sidewalls 93 orthogonally disposed below the top surface of the flapper 90. The sidewalls 93 thus limit lateral motion of the flapper 90 within the cover housing 91 while ensuring beverages are funneled into the spout 92. In the embodiment depicted, the exitway has an open bottom, thus permitting the free flow of the contents of the container 2-2 into exitway and through the spout 92.

Apparatus for penetrating the covering 22 may be modified as desired. For example, in FIG. 9A, the cutting member 31 serves to pierce the covering. FIG. 9B depicts a pushing member 39 which serves to push through the covering 22. One skilled in the art will understand that a variety of techniques may be employed to destroy the integrity of the covering 22, thus releasing the beverage concentrate 36. As such techniques may involve any one or more of cutting, rupturing, severing, puncturing, piercing, pushing or others, it is considered that these terms are generally interchangeable in regard to disrupting the integrity of the covering 22. Accordingly, in this context, a “cutting system” contemplates a system capable of exerting physical force necessary for disruption of the covering 22, thus providing for release of the beverage concentrate 36.

Preferably, the cover 6-2 includes a vent 74 to minimize pressure gradients during use. The cover 6-2 may include other features as desired, such as detents 96 useful for hand tightening the cover 6-2 and for the user to insert their fingers under the top of the flap to pull it back up from the depressed position. Such hand tightening may be desirable where the cover housing 91 includes a thread for mounting onto the container 2-2. Preferably, the cover 6-2 includes a sealing member 27 for protecting against leakage.

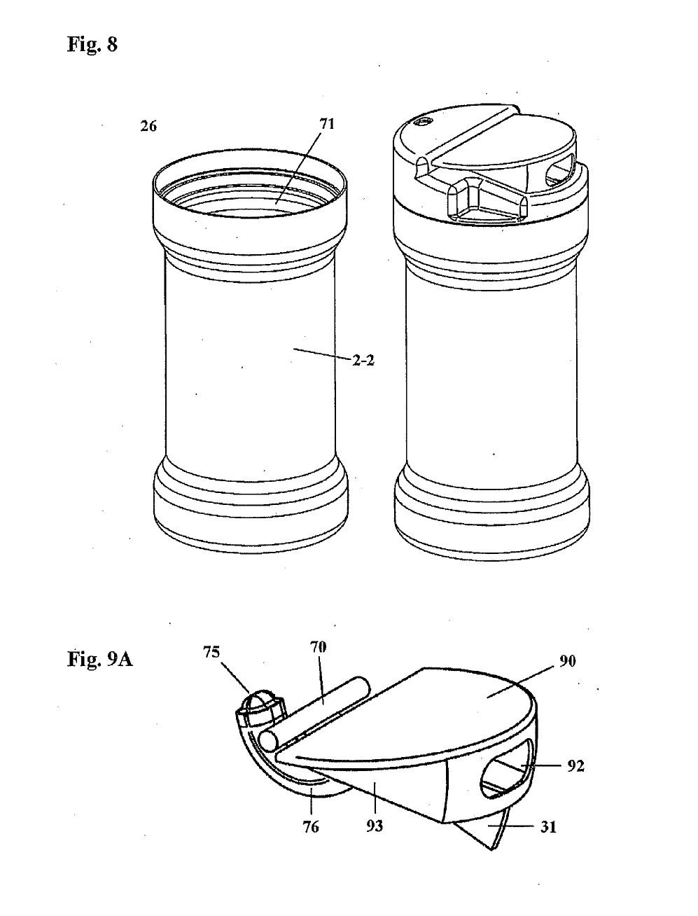

Referring back to FIG. 7 and FIG. 8, the container 2-2 preferably includes a carrier shelf 71 for mounting of a flow through type of carrier 20-2. The carrier shelf 71 may include a cross member 72 which supports the flow through carrier 20-2 across the diameter of the container 2-2. The container 2-2 preferably includes features such as the sealing recess 26 to complement the sealing member 27 in the cover 6-2. The flow through carrier 20-2 provides for flow of the volume of liquid through both the top and the bottom of the compartment 21.

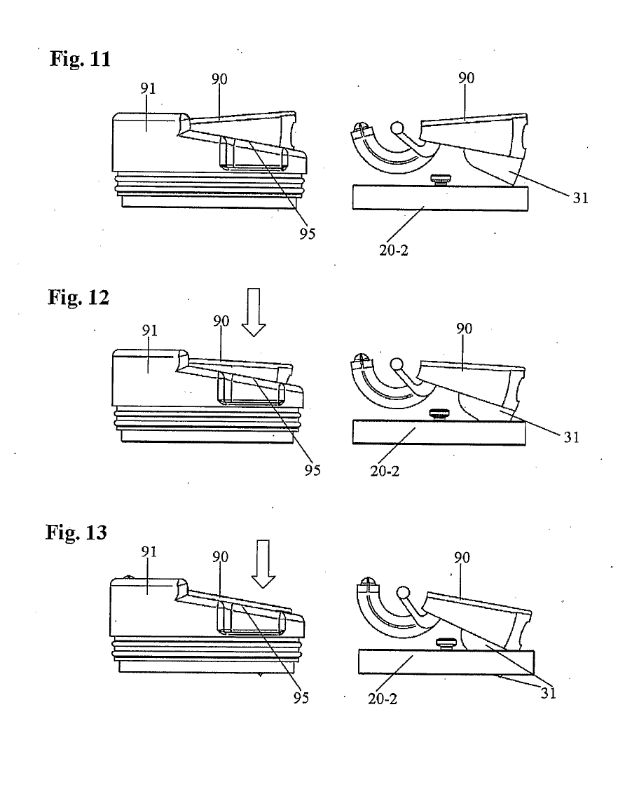

Depressing the flapper 90 causes the release and some degree of mixing of the beverage concentrate 36. Referring to FIG. 11, FIG. 12 and FIG. 13, the cycle of the flapper 90 is shown. In FIG. 11, the flapper 90 is depicted in a relaxed and upward state. It FIG. 12, downward motion, as depicted by the arrow, causes the cutting member 31 to penetrate or push out the upper covering 22-1 of the flow through carrier 20-2. FIG. 13 depicts the flapper 90 pushed to the downward limit wherein the cutting member 31 also penetrates or pushes out the lower covering 22-2 of the flow-through carrier 20-2 to allow the beverage contents 36 to be released into the container 2-2. Further motion of the flapper 90 is restricted by the shelf 95. Note that in FIG. 13, the cutting member 31 has pierced the bottom portion of the flow through carrier 20-2.

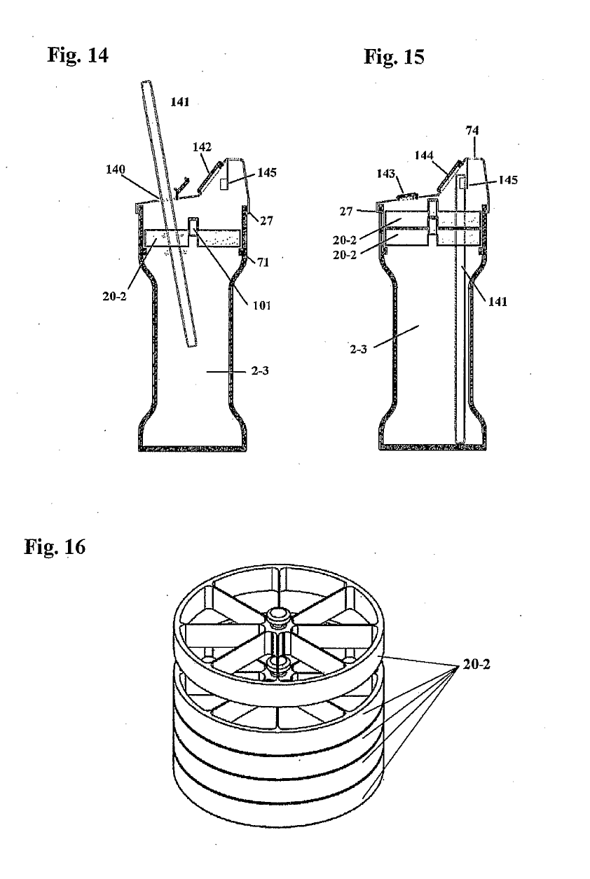

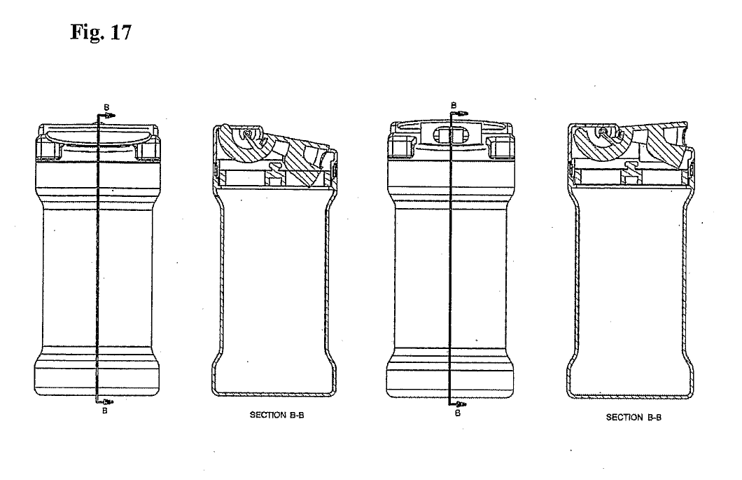

Referring to FIG. 10, the second type of carrier 20, the flow through carrier 20-2 is shown in more detail. The flow through carrier 20-2 includes a bottom covering 22-2, which is similar to the top covering 22-1. That is, the bottom covering 22-2 may be formed of the same materials as the top covering 22-1, and attached to the body of the flow through carrier 20-2 in the same manner as the top covering 22-1 is attached to the cup-type carrier 20-1. Preferably, the bottom covering 22-1 and the top covering 22-2 (collectively referred to as the coverings 22) for the flow through carrier 20-2 include an open center 102 to accommodate a spindle 101. The spindle 101 may be included in the flow through carrier 20-2 to provide a handle thereto for manual manipulation or for other purposes. For example, in some embodiments, the spindle may serve as a lock to retain the carrier 20-2 in the lid (for example, by having the spindle 101 push into a receiving “female” cavity on the underside center of the cover 6-2) that retains the carrier 20-2 when the cover 6-2 is removed (such as for refilling with water). In this event the additional step of having to remove the carrier 20-2 from the container 2-2 when the cover 6-2 is being removed. In another embodiment, a mechanism may be included in the container system 10 to provide rotation of the flow through carrier 20-2 through driving a gear attached to the spindle 101. In such embodiments, as a user depresses the flapper 90, the depression causes the rotation of the flow through carrier 20-2 through the spindle 101. Preferably, the bottom portion of the spindle 101 is hollow, thus providing a feature for stacking of carriers 20-2. Stacking of carriers 20-2 may be convenient for retail packaging of the flow through carrier 20-2, an example being presented in FIG. 16. Stacking of flow through carriers 20-2 may also be convenient for containers 2-2 having large volumes. Another exemplary embodiment of the container system 10, and one that provides for using combinations of flow through carriers 20-2, is depicted in FIG. 14 and FIG. 15.

Referring to FIG. 14, there is shown a container system 10 for reconstitution of a beverage concentrate. The container system 10 includes a container 2-3 and a cover 6-3. As depicted, the container 2-3 includes the carrier shelf 71 for mounting of the flow through carrier 20-2. In this embodiment, the cover 6-3 includes a first passageway 140. The first passageway 140 may be used for insertion of a straw 141, which is used to perforate the flow through carrier 20-2, as well as provide a means for the user to withdraw reconstituted beverage. Referring also to FIG. 15, the cover 6-3 may include a second passageway 142. The second passageway 142 may be used to provide a vent for the container system 10, as well as access to storage for the straw 141. Preferably, in this embodiment, the first passageway 140 includes a first door 143 and the second passageway 142 includes a second door 144. The first door 143 and the second door 144 preferably seal the cover 6-3 to prevent leakage when closed over the respective passageway. In one embodiment, the second door 144 may be opened to permit access to a clamp 145 for storing the straw 141. Preferably, the clamp 145 is coupled to the cover 6-3. In one embodiment, storage of the straw 141 calls for insertion of the straw 141 through the second door 144 and into the container 2-3 with clamping of the straw 141 occurring at the top portion thereof. In another embodiment, storage of the straw 141 calls for removing the cover 6-3, clamping the top end of the straw 141 into the cover 6-3, and then securing the cover 6-3 upon the container 2-3.

Preferably, the straw 141 is formed of a robust material, such as a hard thermoplastic, and includes a sharp point useful for puncturing the coverings 22. Many different types of straws may be used, however, one salient test for the functionality of the varying types of straws is the ability of each straw to perforate the coverings 22 of the flow through carrier 20-2.

As shown in FIG. 15, multiple flow-through carriers 20-2 may be used in this embodiment (as well as some others). Accordingly, the user may use one size of flow through carrier 20-2 with a variety of container sizes. That is, a double size container 2-3 may conveniently include room for two or more flow through carriers 20-2, thus providing for control over the mixing ratios.

Preferably, the desired compartment 21 is selected for consumption through manual rotation of the flow through carrier 20-2. This may be accomplished by use of the straw 141, by manual placement of the carrier 20 prior to installing the cover 6-3, or through other techniques. One example of another technique involves an embodiment wherein the cover 6-3 includes a penetration for an elongated spindle 101, the elongated spindle 101 being inserted through the cover 6-3.

It should be noted that the straw 141 may be stored in the container 2-3 in various configurations. For example, in one embodiment, the straw 141 is inserted through emptied compartments 21 of the flow through carrier 20-2. In another embodiment, the container 2-3 includes an access way, which provides for storage of the straw 141 next to the carrier 20.

The above described container system 10 provides numerous benefits to producers, retailers and consumers. With respect to producers, some of the benefits include the reduction of packaging and distribution costs by the elimination of a container that has only a one-time use and by increase in packaging and distribution of smaller holder/concentrate packages without the liquid. With respect to retailers, some of the benefits include reductions in shelf space required to stock expanded food and beverage choices. With respect to consumers, some of the benefits include enhanced access to desirable beverages, with minimal transport or storage requirements.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

One skilled in the art will recognize that a variety of modifications to the foregoing embodiments may be practiced while remaining consistent with the teachings herein. Some examples include use of various other materials to construct embodiments of the container system 10 disclosed herein. In addition, a variety of manufacturing techniques may be used which call for certain modifications to the structures disclosed. For example, one skilled in the art will recognize that use of a sealing ring 27 or sealing member 27, alone or in combination with a sealing recess 26 is not necessarily required and that this sealing system or other sealing systems may be used. That is, other techniques are known for providing adequate assurance against leakage, any one of which, or combinations thereof, may be used with the teachings herein. Accordingly, it is considered that such modifications are within the teachings contemplated by this disclosure.

What is claimed is:

1. A beverage container system for preparing a beverage from a beverage concentrate, the container system comprising:
a container for holding a liquid volume, the system further comprising a mounting system coupled thereto for holding at least one carrier, wherein each carrier comprises multiple compartments comprising the beverage concentrate, the system further comprising a cutting system coupled thereto for piercing at least one of the multiple compartments, wherein, when the at least one of the multiple compartments is pierced the beverage concentrate is commingled with the liquid volume to produce the beverage within the container.

2. The beverage container system as in claim 1, wherein the mounting system comprises a removable base for holding at least one carrier.

3. The beverage container system as in claim 2, wherein the removable base further comprises a cam track for selecting the at least one of the multiple compartments for piercing.

4. The beverage container system as in claim 1, wherein the at least one carrier comprises at least one of a cup type carrier and a flow through carrier.

5. The beverage container system as in claim 1, wherein at least one of the cutting system and the mounting system is coupled to a detachable base to the container.

6. The beverage container system as in claim 1, wherein at least one of the cutting system and the mounting system is coupled to a detachable cover to the container.

7. The beverage container system as in claim 1, further comprising a sealing system for preventing leakage of one of the liquid volume and the beverage.

8. A method for producing a beverage container system for preparing a beverage from a beverage concentrate, comprising:
selecting a mounting system for holding at least one carrier comprising multiple compartments comprising the beverage concentrate;
selecting a cutting system for piercing at least one of the multiple compartments;
selecting a container for holding a liquid volume; and
coupling the mounting system and the cutting system to the container to produce the container system.

9. The method as in claim 8, wherein coupling comprises at least one of injection molding, screwing, gluing, interlocking and melting at least one the container, the cutting system and the mounting system.

10. The method as in claim 8, wherein producing further comprises injection molding a body of the at least one carrier.

11. The method as in claim 8, wherein producing further comprises loading the multiple compartments of the at least one carrier with at least one beverage concentrate.

12. The method as in claim 11, wherein producing further comprises sealing the beverage concentrate into the at least one carrier with at least one covering.

13. The method as in claim 8, wherein coupling the mounting system comprises at least one of a coupling the mounting system to one of a detachable base, a detachable cover and the container.

14. The method as in claim 8, wherein selecting a cutting system component comprises at least one of selecting a cutting member and selecting a straw.

15. A method for producing a beverage, comprising:
selecting a container for holding a liquid volume, the container comprising a mounting system coupled thereto for holding at least one carrier, wherein each carrier comprises multiple compartments comprising the beverage concentrate, the container further comprising a cutting system coupled thereto for piercing at least one of the multiple compartments, wherein, when the at least one of the multiple compartments is pierced the beverage concentrate is commingled with the liquid volume to produce the beverage within the container;
filling the container with the liquid volume;
mounting at least one carrier into the container, and
piercing at least one of the multiple compartments.

16. A beverage concentrate container comprising:
a carrier adapted for use in a container system, the container system having a cutting system for releasing the beverage concentrate supply, the carrier having multiple compartments for containing at least one beverage concentrate and at least one covering there over for sealing the beverage concentrate within each of the multiple compartments.

17. The beverage concentrate container as in claim 16 wherein the at least one covering comprises a film of rupturable material.

18. A beverage concentrate container as in claim 16 wherein the carrier comprises at least one of a carousel and a straw.

19. A beverage container system for preparing a beverage from a beverage concentrate, the beverage container system comprising:
a container means for holding a liquid volume, the container means comprising a mounting means coupled thereto for holding at least one carrier means, wherein each carrier means comprises multiple compartments comprising the beverage concentrate, the beverage container system further comprising means for cutting coupled thereto, the cutting means for releasing beverage concentrate from at least one of the multiple compartments, wherein, when the beverage concentrate is released, the beverage concentrate is commingled with the liquid volume to produce the beverage within the container means.

20. The beverage container system as in claim 19, wherein the cutting means comprises at least one of a piercing means and a pushing means.
